(19) United States
(12) Patent Application Publication
(10) Pub. No.: US 2013/0257595 A1
(43) Pub. Date: Oct. 3, 2013

(54) DETERMINING A POSITION BY MEANS OF RFID TAGS

(71) Applicants: Volker Trösken, Witten (DE); Laszlo Hasenau, Bochum (DE)

(72) Inventors: Volker Trösken, Witten (DE); Laszlo Hasenau, Bochum (DE)

(21) Appl. No.: 13/818,045

(22) PCT Filed: Aug. 22, 2011
(86) PCT No.: PCT/EP11/04213

§ 371 Date: Jun. 17, 2013

(30) Foreign Application Priority Data
Aug. 23, 2010 (DE) 10 2010 035 155.5

(51) Int. Cl. G06K 7/10

(52) U.S. Cl. CPC G06K 7/10297
USPC 340/10.1

(57) ABSTRACT

The invention relates to a method for determining the spatial position and/or orientation of an object (1) marked by means of at least one transponder (2, 2′), wherein the transponder (2, 2′) receives a query signal emitted by a transmitting device (3) and is excited thereby in order to emit a locating signal, wherein the locating signal is received by means of at least one receiving device (5) and is analyzed by means of an evaluating device (7) to determine the position. The object of the present invention is to provide a method that is improved in terms of practicability and above all in terms of precision in determining a position. For this purpose, the transmitting device (3) inventively emits the query signal intermittently, wherein the receiving device (5) receives at least the locating signal emitted by the transponder (2, 2′) during the transmission pauses of the transmitting device (3) and the evaluating device (7) determines the position is therefrom. The invention further relates to a system for carrying out the method.

The invention relates to a method for determining the spatial position and/or orientation of an object marked by means of at least one transponder, wherein the transponder receives a query signal emitted by a transmitting device and is excited thereby in order to emit a locating signal, wherein the locating signal is received by means of at least one receiving device and is analyzed by means of an evaluating device to determine the position. The invention further relates to a system for determining the position, said system comprised of at least one transponder attachable to an object, and comprised of a transmission unit to emit a query signal receivable by the transponder, a plurality of receiving devices situated at various sites for receiving a locating signal emitted by the transponder, and an evaluating device for analyzing the locating signal received.

In medical science, for example, a precise determination of the position of an applied medical instrument is of paramount importance in various diagnostic and therapeutical methods. Instruments of this kind, for example, may be intravascular catheters, guidance wires, biopsy needles, minimally invasive surgical instruments, endoscopes or the like. Those systems being of a particular interest are systems for determining the spatial position and site of a medical instrument in the field of interventional radiology, neurosurgery, orthopedics or radiotherapy, too. A plurality of potential applications for precise position determination systems, however, also exists outside the field of medicine.

WO 2007/147614 A2 discloses a system for determining the spatial position and/or orientation of a medical instrument, comprising a transmission unit emitting a query signal in form of electromagnetic radiation and at least one transponder arranged on the medical instrument in form of an RFID tag. The RFID tag is comprised of an antenna and a circuit connected to the antenna for receiving and transmitting electromagnetic radiation, wherein the circuit can be excited by the query signal received via the antenna, i.e. in such a manner that it emits a locating signal as electromagnetic radiation via the antenna. Several receiving units are provided for which receive the locating signal emitted from the transponder. From the field intensity and from the phase of the locating signal at the site of the relevant receiving unit, conclusions on the precise position of the transponder can be drawn. An evaluating unit linked to the receiving units determines the spatial position and/or orientation of the transponder and thus of the medical instrument from the locating signal emitted from the transponder.

With the prior art system, there is a problem in practice in that the evaluation of the comparably weak locating signal of the RFID tag, in particular with regard to the phase relation of the locating signal at the relevant site of the receiving device is difficult. The reason is that the receiving devices in parallel to the locating signal also receive the query signal of the transmission device. The latter is by up to 100 dB stronger than the locating signal. Since a separation of the query signal of the transmission device from the locating signal of the transponder is not or at least not adequately possible, adequate precision in determining the position cannot be achieved.

Against this background it is the object of the present invention to provide a method and system which is improved in terms of practicability and above all in terms of precision in determining the position.

This task is solved by the present invention based upon a method of the type indicated hereinabove in such a manner that the transmission device emits the query signal intermittently, wherein the receiving device receives at least the locating signal emitted by the transponder during the transmission pauses of the transmission device and wherein the evaluating device determines the position therefrom, i.e. precisely to a few centimeters, a few millimeters or even less than one millimeter.

Implemented as a marker for position determination with the inventive method is a transponder, as has been outlined hereinabove, preferably in form of a customary RFID tag (e.g. according to the so-called “EPC Global Standard”). As is well known, RFID is a technology for non-contact identification and tracking. An RFID system is comprised of a transponder and a reader device for reading out the transponder identification. This reader device forms a transmission device in the sense of the present invention. Usually an RHO tag comprises an antenna as well as an integrated electronic circuit with an analog and a digital part. The analog part (transceiver) serves for receiving and transmitting electromagnetic radiation. The digital circuit comprises a data storage in which identification data of the transponder are storable. With more complex RFD transponders, the digital part of the circuit has a Neumann architecture. The high-frequency electromagnetic field generated by the reader device forms the query signal in the sense of the present invention. It is received via the antenna of the RFID transponder. As soon as the antenna is situated in the electromagnetic field of the reader device, an induction current activating the transponder is created in the antenna. The transponder thus activated receives commands from the reader device via the electromagnetic field. The transponder generates a response signal which contains the data inquired for by the reader device. In accordance with the present invention, the response signal is the locating signal based upon which the spatial position of the marking is acquired.

Passive RFID tags as well as active RFID tags (e.g. for extending the range) are suitable for the inventive method.

The invention takes advantage of the knowledge that the query signal of the transmission device can be interrupted during short time intervals (approx. 100 to 500 μs), without this adversely affecting the communication between the transmission device and the transponder. In particular it becomes evident that the transponder after having been excited by the query signal has stored sufficient energy and continues to emit the locating signal during transmission pauses of the transmission device. In accordance with the invention, the locating signal is received during transmission pauses of the transmission device and analyzed by means of the evaluating device for determining the position. Thus the locating signal is received without interfering superimposition by the query signal. This allows for substantially increasing the sensitivity and precision in determining the position. With customary RFID tags, it is thus possible to perform a position determination with millimeter precision.

In accordance with a preferred embodiment of the inventive method, the determination of the position by means of the evaluating device is accomplished based on the phase relation of the electromagnetic radiation of the locating signal at the site of the receiving device. Its background is that the field intensity of the locating signals may be subject to fluctuations, for example due to signal reflections from the environment. For this reason, a determination of the position based upon field intensity, i.e. based upon the amplitude of the electromagnetic radiation of the locating signals emitted from the transponder might not always be feasible with adequate accuracy. The phase relation responds with less sensitivity to interfering ambient influences than the amplitude of the electromagnetic radiation of the locating signals. It is also conceivable that a rough position determination based upon the amplitude is made initially, refining the accuracy by determining the phase relation. Determining the position based on the phase relation also allows for higher accuracy than determining the position based upon the signal amplitude. On account of the periodicity of the electromagnetic radiation, a position determination based upon the phase relation, however, might not be unambiguous. It is either required to maintain a restricted measuring volume within which clear-cut conclusions can be drawn from the phase relation to the position, or it is required to take additional measures. Here, a combination of measuring the signal amplitude with measuring the phase relation may remedy the situation. As an alternative or in addition thereto, it is possible to count the zero crossings of the locating signal at the sites of the relevant receiving devices during the movement of the object in order to draw clear-cut conclusions on the correct position.

An inventively applied receiving device typically comprises an antenna connected to corresponding receiver electronics (HF network, amplifier, demodulator, etc.). In the sense of the invention, the term “site of the receiving device” is equivalent to the site of the antenna. What matters for determining the position is the phase and/or amplitude of the electromagnetic radiation of the locating signal at the site of the antenna. The antenna may be spatially separated from the pertinent receiver electronics, the antenna being connected for example via a cable to the receiver electronics. Also conceivable is a variant in which several antennae are connected to a receiver electronics comprised of several channels. In this case, too, it is valid in the sense of the invention that the “site of the receiving device” means the site of the relevant antenna.

In a preferred embodiment of the inventive method, the determination of the orientation of the object marked by a unique transponder by means of the evaluating device is accomplished based upon the phase relation of the electromagnetic radiation of the locating signal at the site of the receiving device. This approach takes advantage of the fact that the transponder has characteristic anisotropic emission characteristics. The orientation of the object in the space (determined by the angles, assuming at least a specific axis of the object relative to the coordinate axes) takes effect on the phase relation in a defined manner. This can be utilized for determining the orientation, even though the object is marked with a unique transponder only.

In accordance with an appropriate development of the invention, it may be provided for that the electromagnetic radiation of the locating signal is received by means of two or more receiving devices situated at different sites, wherein a phase differential value derived from the received locating signal is generated and fed to the evaluating device for determining the position. From the locating signal received from two different positions each, it is possible, for example, to form the phase difference. It is also feasible that a phase detector is allocated to each receiving device, said phase detector being supplied with a reference signal standing in constant phase relationship to the query signal for generating the phase difference. The measurement of the phase difference instead of the absolute phase relation is advantageous, because the electromagnetic radiation of the locating signal emitted from the relevant transponder initially has no defined absolute phase relation. With advantage, customary and low-price phase detectors like those utilized for example in PLL components can be used for measuring the phase differences. Frequently, signal amplifiers for amplifying the signals received are already integrated in such PLL components.

The procedure expediently applied in determining the position based on phase differences is such that the phase differential values derived from the locating signal received are compared with reference phase differential values (e.g. those saved in the evaluating device). A simple comparison, possibly in combination with an interpolation, can be made with the saved reference phase differential values which are appropriately allocated to x, y and z coordinates. As an alternative, determining the position can be accomplished by means of a neuronal network which is supplied with the phase differential values as input values, said phase differential values generated from the locating signal received. Then situated at the output of the neuronal network are the space coordinates which the momentary position of the relevant marking results from.

It is expedient to perform a calibration measurement in advance in which reference phase differential values are acquired for a plurality of predefined positions. These can simply be saved together with the space coordinates of the predefined positions in an appropriate data matrix. Likewise, the neuronal network mentioned before can be trained on the basis of the calibration measurement. It is furthermore purposive to look up for a predefined reference point regularly with the object and/or marking independently of the calibration. This can be utilized to carry out an adjustment relative to the coordinate origin within regular intervals. In determining the position, a shift in the coordinate origin can be easily compensated for, if required, by way of a simple vector addition, without this calling for a renewed complete recalibration.

For the purpose of calibration, in accordance with a preferred embodiment of the invention, a plurality of reference transponders located at predefined positions can be provided for recording reference phase differential values. This allows for carrying out a continuous calibration, for example in order to continuously adapt the reference phase differential values for position determination to varying ambient conditions. To this effect, the calibration measurement can be repeated within regular cycles.

Furthermore preferred is an embodiment of the inventive method in which the locating signal emitted from the transponder is pulse-shaped. Expediently the output signal of the phase detector is initially digitalized, i.e. with a scanning frequency that is greater than the pulse frequency of the locating signal. Then the phase differential value can be derived from the received locating signal by way of suitable digital signal processing based on the output signals of the phase detector. By means of an appropriate algorithm for signal processing, signal noise and other signal interferences can be effectively suppressed. The signals emitted from the inventively utilized RFID tag are pulse-shaped. For a digital data transfer between RFID tag and reading device is usually accomplished via signal pulses. In accordance with the invention, this can be exploited for acquiring the phase differential values needed for determining the position as described hereinabove in a reliable and low-noise manner.

The invention furthermore relates to a system for position determination, said system comprised of at least one transponder attachable to an object, and comprised of a transmission device to emit a query signal receivable by the transponder, a plurality of receiving devices situated at various sites for receiving a locating signal emitted by the transponder, and an evaluating device (7) for analyzing the locating signal received. The a.m. task is solved in that the transmitting device is equipped for intermittently emitting the query signal, wherein the transponder emits the locating signal at least during the transmission pauses of the transmitting device.

In a preferred embodiment of the system, the evaluating device is equipped for determining the spatial position of the transponder by analyzing the locating signal received during the transmission pauses of the transmission device.

It is furthermore preferred with the inventive system to allocate a phase detector to each receiving device, said phase detector being supplied with a reference signal at least during the transmission pauses of the transmission device, said reference signal standing in a constant phase relationship with the query signal.

The inventive system can be applied in various fields,

In medicine (e.g. in the fields of interventional radiology, neurosurgery, orthopedics or radiotherapy), the system can be utilized for determining the position of a medical instrument marked by one or more RFID tags precisely to a millimeter. The position recorded can be visualized in a suitable manner for the purpose of navigation, for example by displaying the instrument on a screen visible to the surgeon, with the representation of the instrument being superimposed with medical image data (e.g. X-ray, CT, ultrasonic or MR images).

Furthermore conceivable is a use of the inventive system in instrumental analytics, i,e, for determining the position and/or orientation of a sample marked by at least one transponder or of a sample container. On the one hand, the transponder allows for determining the position of a sample within a corresponding analytical measuring arrangement. On the other hand, the sample can be identified automatically based on the transponder.

Furthermore, the inventive system lends itself suitable for application in automated manufacturing technology (e,g, in automobile industry or in aviation and aerospace technology), for determining the position and/or orientation of a component, workpiece or manufacturing automat marked by at least one transponder. In this manner, one can determine at any time the position of a distinct (identifiable by means of the transponder) workpiece to be processed, or component to be mounted in order to control the applied manufacturing automats accordingly. Even the position of manufacturing automats themselves, i.e. for example the momentary site, position and orientation of tool or grab linked to the manufacturing automat can be acquired and monitored. Moreover, for the purpose of quality assurance upon completed processing or mounting, one can check the proper position of the workpiece and component, respectively,

Further fields of application of the present invention arise in the field of motion capture. This term relates to processes which enable recording the movement of objects, and for example of human beings, too, and digitalizing recorded data so that digital movement data can be analyzed and saved, for example by means of a computer. Frequently, the recorded digital movement data are utilized for transferring these to computer-generated models of the relevant object. Such techniques are common practice nowadays in the production of movies and computer games. Digitally recorded motion data are utilized, for example, to compute three-dimensional animated graphics in a computer-aided manner. Complex motion sequences can be analyzed by means of a computer in motion capture in order to generate animated computer graphics at comparably low expenditure or to control devices of consumer entertainment electronics (e.g. computer game consoles). By means of motion capture, it is possible to record the most different types of movements, viz. rotations, translations as well as deformations of objects investigated. It is also feasible to record movements of inherently movable objects that have several joints as is the case with human beings, for example, which can execute movements independently of each other. The generic term of motion capture also covers the so-called “performance capture” technique. With this technique, it is not only body movements but also facial expressions, i.e. the mimic of persons that is recorded and computer-analyzed as well as processed further. In accordance with the invention, one or more RFID tag(s) are attached to the relevant object for motion capture, and their spatial positions are recorded and digitalized.

Practical examples of the invention are outlined in the following by way of drawings, where:

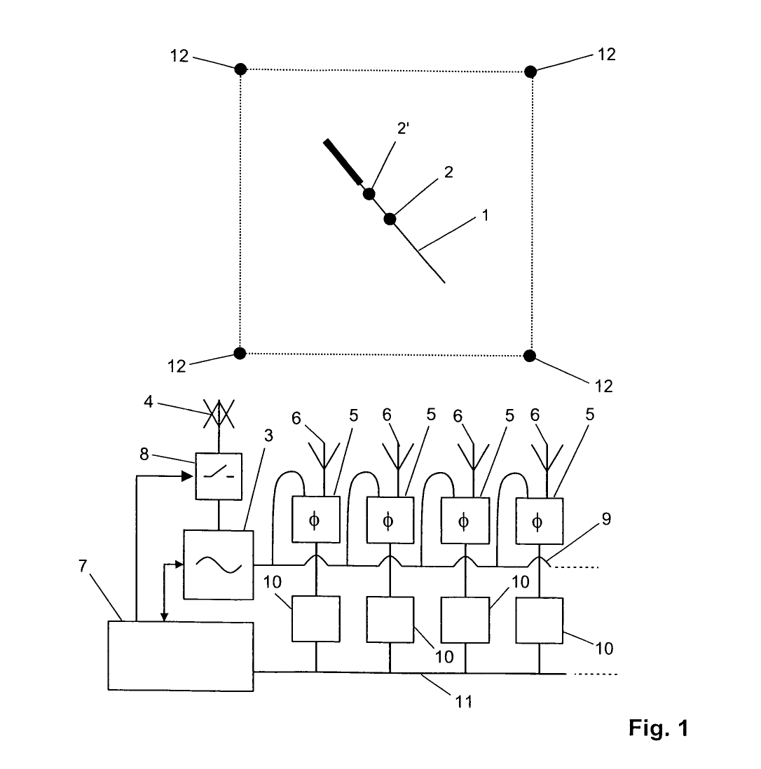

FIG. 1: shows a schematic representation of an inventive system as a block diagram;

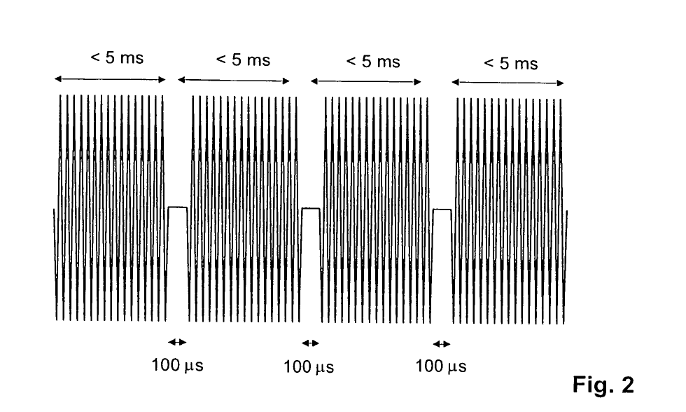

FIG. 2: shows a chronology of the query signal intermittently emitted according to the invention;

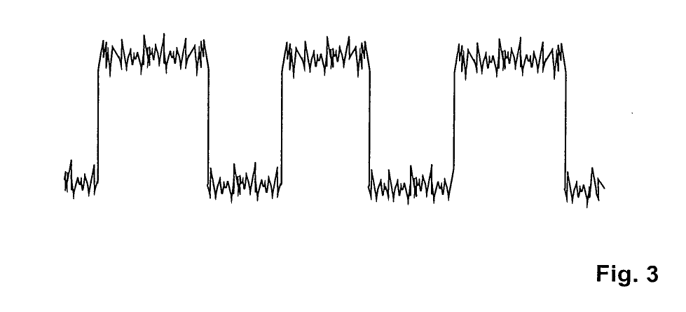

FIG. 3: shows an output signal of one of the phase detectors in the system according to FIG. 1.

The system shown schematically in FIG. 1 serves for determining the spatial position and orientation of a medical instrument 1, for example a biopsy needle. Arranged at the medical instrument 1 are transponders 2 and 2′ in form of customary passive RFI tags serving as markers for position determination. The system comprises a transmitting device 3 which is also a customary reading device for the RFID Tags 2, 2′. The transmission device 3 emits a query signal via an antenna 4. The electromagnetic radiation of the query signal is received by the transponders 2 and 2′. For this purpose, the transponders 2 and 2′ are equipped with antennae (not shown) in which an induction current is created as soon as the antennae are within the electromagnetic field of the transmission device 3, said induction current activating the transponders 2 and 2′. The transponders 2 and 2′ thus activated generate a locating signal in response to the query signal, here again in form of an electromagnetic radiation. The locating signal is pulse-shaped modulated. Thereby, the transponders 2 and 2′ transmit data queried from the transmission device 3, e.g. the relevant identification numbers of the transponders 2 and 2′. In accordance with the invention, the locating signal queried from the transponders 2 and 2′ is utilized for determining the spatial positions of the transponders 2 and 2′ and thus for determining the position and orientation of the medical instrument 1. With the practical example outlined here, determining the orientation is accomplished by analyzing the relative positions of the two transponders 2 and 2′.

The locating signals from transponders 2 and 2′ are received by means of receiving devices 5 situated at various sites within the space. To this effect, the receiving devices 5 are equipped with suitable receiver antennae 6. An evaluating device 7 is provided for analyzing received locating signals to determine the positions of transponders 2 and 2′.

In accordance with the invention, the receiving device 3 emits the query signal intermittently. Provided to serve this purpose is a switching element 8 actuated by the evaluating device 7 and connecting the receiving device 3 depending on the switching position with the antenna 4 or which disconnects it therefrom. The switching element 8 thus allows for scanning the query signal in a manner controlled by the evaluating device 7.

Each of the receiving devices 5 is comprised of a phase detector which generates a phase differential value derived from the locating signal received. For phase differential control, each phase detector is fed with a reference signal via a reference signal line 9 connected to the transmission device 3, said reference signal standing in a constant phase relationship with the query signal from the transmission device 3. Determining the spatial positions of the transponders 2 and 2′ is accomplished by means of the evaluating device 7 based upon the phase relation of the electromagnetic radiation of the locating signal at the site of the relevant receiving device 5. The outputs of the phase detectors of the receiving devices 5 are connected to digital modules 10. Each of these comprises an analog/digital converter which digitalizes the phase differential values. The digital phase differential values are transmitted to the evaluating device 7 via a data bus 11 which the digital modules 10 are connected with. Further data analysis for position determination is accomplished there. As indicated in FIG. 1, the architecture of the system as illustrated allows for an almost arbitrary number of receiving devices that are linked via the data bus 11 to the evaluating device 7. The receiving devices 5 may be spread flexibly within the space as prompted by requirements in order to ensure a reliable position determination.

The evaluating device 7 inventively utilizes those phase differential values for position determination that are received during transmission pauses from the transmission device 3, i.e. during those time intervals in the course of which the connection between the transmission device 3 and the antenna 4 via the switching element 8 is interrupted. In this manner it is ensured that the query signal from the transmission device 3 does not adversely affect the position determination based on the locating signals from transponders 2 and 2′.

FIG. 2 illustrates the query signal emitted from the transmission device 3 via antenna 4. It can be seen that the query signal is emitted intermittently. During a period of up to 5 ms, the switching element 8 is closed, i.e. during this period the query signal is emitted without obstructions from the transmission device 3 via the antenna 4. The switching element 8 is then opened so that the connection between the transmission device 3 and antenna 4 is interrupted, that means during a period of 100 μs. In the course of this period, the locating signals from transponders 2 and 2′ are received via the receiving devices 5 and analyzed for position determination by means of the evaluating device 7. As outlined hereinabove, the invention takes advantage from the knowledge that the query signal from the transmission device 3 (the reading device) with customary RFID systems can be interrupted during short time periods, i.e. approx. 100 to 500 μs, without this adversely affecting the remaining communication between the transmission device 3 and the transponders 2 and 2′. Exploited in particular is the fact that the transponders 2 and 2′ upon excitation by the query signal from the transmission device 3 have stored sufficient energy to keep on emitting the locating signal even during the transmission pauses of the transmission device 3. Therefore, the locating signals can inventively be received without interfering superimposition by the query signal.

In determining the position based on digitalized phase differential values, the procedure to apply is that the phase differential values are compared by means of the evaluating device 7 with the reference phase differential values saved there. By comparison with saved reference phase differential values, the x, y and z coordinates of the relevant transponder 2 and/or, 2′ are determined.

The medical instrument 1 is situated in an area that is defined by the reference transponder 12. The reference transponders 12 which again are customary RFID tags are located at predefined positions. Via the illustrated system, the is corresponding reference phase differential values are continuously derived from the locating signals of the reference transponders 12. This allows for a continuous post-calibration in position determination.

FIG. 3 schematically shows the output signal of one of the phase detectors of the receiving devices 5 (see FIG. 1). It can be seen that the relevant output signal is afflicted with strong signal noise. Furthermore one can see that the transponders 2 and 2′ emit a pulsed output signal. The signal pulses of the locating signal are reflected in the signal pulses at the output of the phase detectors. The pulsed emission of the locating signals from transponders 2 and 2′ serves for data transfer between transponders 2 and 2′ and the reading device 3. Transmitted are, for example, identification data of transponders 2 and 2′. Thus it is possible to identify the individual transponders 2 and 2′ as well as the reference transponders 12, too. Hence, determining the position can be accomplished individually by means of the evaluating device 7 for each transponder 2, 2′ and/or 12. In accordance with the invention, the phase differential values are recorded in a reliable and low-noise manner by way of digital signal processing. To this effect, the output signal shown in FIG. 3 of each phase detector is initially digitalized by means of digital modules 10, i.e. with a scanning frequency which is greater than the pulse frequency of the locating signal. This approach has the advantage that a remaining weak residual signal of the query signal from the transmission device 3, which is also emitted via antenna 4 while the switching element 8 is open, can be analyzed and eliminated during the phase differential value formation, and that the position determination is not adversely affected or distorted by the residual signal.

1. Method for determining the spatial position and/or orientation of an object (1) marked by means of at least one transponder (2, 2′), wherein the transponder (2, 2′) receives a query signal emitted by a transmitting device (3) and is excited thereby in order to emit a locating signal, wherein the locating signal is received by means of at least one receiving device (5) and is analyzed by means of an evaluating device (7) to determine the position, characterized in that the transmitting device (3) emits the query signal intermittently, wherein the receiving device (5) receives at least the locating signal emitted by the transponder (2, 2′) during the transmission pauses of the transmitting device (3) and the evaluating device (7) determines the position therefrom.

2. Method as defined in claim 1, characterized in that the transponder (2, 2′) is an RFID tag comprised of an antenna, via which the query signal is received in form of an electromagnetic radiation and via which the locating signal is emitted in form of an electromagnetic radiation.

3. Method as defined in claim 1, characterized in that the duration of the transmission pauses amounts up to 500 μs, preferably up to 200 μs, and in particular preferably up to 100 μs.

4. Method as defined in claim 1, characterized in that the determination of the position by means of the evaluating device (7) is accomplished based upon the phase relation of the electromagnetic radiation of the locating signal at the site of the receiving device (5).

5. Method as defined in claim 1, characterized in that the determination of the orientation is accomplished by means of an object (1) marked by means of a unique transponder by way of the evaluating device (7) based upon the phase relation of the electromagnetic radiation of the locating signal at the site of the receiving unit (5).

6. Method as defined in claim 4, characterized in that a rough determination of the position is initially accomplished based on the amplitude of the electromagnetic radiation of the locating signal at the site of the receiving unit (5), wherein the accuracy in determining the position is subsequently increased by determining the phase relation.

7. Method as defined in claim 6, characterized in that the electromagnetic radiation of the locating signal is received by means of two or more receiving devices (5) situated at various sites, wherein at least one or more phase difference value(s) (ΔΦ) derived from the received locating signal are generated by at least one phase detector and fed to the evaluating device (7) for position determination.

8. Method as defined in claim 7, characterized in that a phase detector is allocated to each receiving device (5), said phase detector being fed with a reference signal standing in constant phase relationship with the query signal for phase difference generation.

9. Method as defined in claim 7, characterized in that the locating signal emitted from the transponder (2, 2′) is pulse-shaped, wherein the output signal of the phase detector is digitalized with a scanning frequency which is greater than that of the pulse frequency of the locating signal.

10. Method as defined in claim 9, characterized in that the phase difference value (ΔΦ) is determined from the digital values by means of digital signal processing.

11. Method as defined in claim 7, characterized in that the position determination is accomplished by comparing the phase differential values (ΔΦ) derived from the locating signal received with the reference phase differential values saved in the evaluating device.

12. Method as defined in claim 11, characterized in that a calibration measurement is executed in which reference phase differential values are acquired for a plurality of reference transponders (12) located at predefined positions.

13. Method as defined in claim 12, characterized in that the calibration measurement is repeatedly executed.

14. System for position determination, said system comprised of at least one transponder (2, 2′) attachable to an object (1), and comprised of a transmission device (3) to emit a query signal receivable by the transponder (2, 2′), a plurality of receiving devices (5) situated at various sites for receiving a locating signal emitted by the transponder (2, 2′), and an evaluating device (7) for analyzing the locating signal received, characterized in that the transmitting device (3) is equipped for intermittently emitting the query signal, wherein the transponder (2, 2′) emits the locating signal at least during the transmission pauses of the transmitting device (3).

15. System as defined in claim 14, characterized in that the evaluating device (7) is equipped for determining the spatial position of the transponder (2, 2′) by analyzing the locating signal received during the transmission pauses of the transmission unit (3).

16. System as defined in claim 14, characterized in that a phase detector is allocated to each receiving device (5), said phase detector being fed at least during the transmission pauses of the transmission unit (3) with a reference signal standing in a constant phase relationship with the query signal.

17. Use of a system as defined in claim 14 in medicine for determining the position and/or orientation of a medical instrument marked by means of at least one transponder.

18. Use of a system as defined in claim 14 in instrumental analytics for determining the position and/or orientation of a sample marked by means of at least one transponder.

19. Use of a system as defined in claim 14 in automated manufacturing technology for determining the position and/or orientation of a component, workpiece, or manufacturing automat marked by means of at least one transponder.

20. Use of a system as defined in claim 14 in consumer entertainment electronics to acquire the position and/or orientation of an object marked by means of a transponder, wherein a device of consumer entertainment electronics is controlled based upon the acquired position and/or orientation of the object.

21. Use of a system as defined in claim 14 for tracking a person whose body is marked by means of transponders at several spots.
